(19) United States
(12) Patent Application Publication
(10) Pub. No.: US 2021/0263470 A1
(43) Pub. Date: Aug. 26, 2021

(54) TIMEPIECE COMPONENT CONTAINING A HIGH-ENTROPY ALLOY

(71) Applicant: Nivarox-FAR S.A., Le Locle (CH)

(72) Inventors: Christian CHARBON, Chezard-St-Martin (CH); Guido PLANKERT, Boppelsen (CH)

(73) Assignee: Nivarox-FAR S.A., Le Locle (CH)

(21) Appl. No.: 17/177,426

(22) Filed: Feb. 17, 2021

Related U.S. Application Data
(63) Continuation of application No. 16/775,657, filed on Jan. 29, 2020, now Pat. No. 11,042,120.
Application No. 16/775,657 is a continuation of application No. 16/331,038, filed on Mar. 6, 2019, now abandoned.

(30) Foreign Application Priority Data
Sep. 30, 2016 (EP) 16191867.7

(51) Int. Cl. G04B 1/14; G04B 29/02; G04B 5/16; G04B 13/02; G04B 37/22; C22C 27/06; C22C 38/30; C22C 38/38; C22C 38/52

(52) U.S. Cl. CPC G04B 1/145; G04B 29/027; G04B 5/16; G04B 13/026; C22C 38/52; C22C 27/06; C22C 38/30; C22C 38/38; G04B 37/22

(57) ABSTRACT

The invention concerns a timepiece component containing a high-entropy alloy, the high-entropy alloy containing between 4 and 13 main alloying elements forming a single solid solution, the high-entropy alloy having a concentration of each main alloying element comprised between 1 and 55 at. %.

### CROSS REFERENCE TO RELATED APPLICATIONS

The present application is a continuation of U.S. Ser. No. 16/775,657, filed Jan. 29, 2020, pending, which is a continuation of U.S. Ser. No. 16/331,038, filed Mar. 6, 2019, now abandoned, which is a 371 of PCT application no. PCT/EP2017/069219, filed Jul. 28, 2017, now inactive, and claims priority to European application EP16191867.7, filed Sep. 30, 2016.

### FIELD OF THE INVENTION

The present invention concerns a timepiece component containing a high-entropy alloy, and a method for fabricating such a timepiece component. The invention also concerns the use of a high-entropy alloy for fabricating a timepiece component.

### PRIOR ART

Timepiece components, and especially mainsprings, are subjected to high stresses, particularly during fabrication processes, but also during use.

They must, in particular, offer high mechanical strength and high ductility. However, at present, timepiece components rarely simultaneously offer these antagonistic features.

### SUMMARY OF THE INVENTION

It is an object of the invention to overcome the drawbacks of the state of the art by proposing a timepiece component offering higher mechanical strength and higher ductility.

To achieve this, there is proposed, according to a first aspect of the invention, a timepiece component containing a high-entropy alloy, the high-entropy alloy containing between 4 and 13 main alloying elements forming a single solid solution, the high-entropy alloy having a concentration of each main alloying element comprised between 1 and 55 at. %. Indeed, such a component has higher mechanical strength and higher ductility than those of the prior art.

Advantageously, the concentration of each main alloying element is comprised between 10 and 55 at. %.

According to different preferred embodiments:
the high-entropy alloy may satisfy the following formula: FeₐMn_{b}Co_{c}Cr_{d} where a, b, c et d are comprised between 1 and 55 at. %;
the high-entropy alloy may have the following formula: Fe₅₀Mn₃₀Co₁₀Cr₁₀;
the high-entropy alloy may satisfy the following formula: Fe₈₀₋ₓMnₓCo₁₀Cr₁₀, where x is comprised between 25 and 79 at. %, and preferably x is comprised between 25 and 45 at. %;
the high-entropy alloy may satisfy the following formula: FeₐMn_{b}NiₑCo_{c}Cr_{d} where a, b, c, d and e are comprised between 1 and 55 at. %;
the high-entropy alloy may satisfy the following formula: Fe₂₀Mn₂₀Ni₂₀Co₂₀Cr₂₀;
the high-entropy alloy may satisfy the following formula: Fe₄₀Mn₂₇Ni₂₆Co₅Cr₂;

the high-entropy alloy may satisfy the following formula: TaₐNb_{b}Hf_{c}Zr_{d}Crₑ where a, b, c, d and e are comprised between 1 and 55 at. %;
the high-entropy alloy may, in particular, satisfy the following formula: Ta₂₀Nb₂₀Hf₂₀Zr₂₀Ti₂₀;
the high-entropy alloy may satisfy the following formula: AlₐLi_{b}Mg_{c}Sc_{d}Tiₑ where a, b, c, d and e are comprised between 1 and 55 at. %;
the high-entropy alloy may, in particular, satisfy the following formula: Al₂₀Li₂₀Mg₁₀Sc₂₀Ti₃₀;
the high-entropy alloy may satisfy the following formula: AlₐCo_{b}Cr_{c}Cu_{d}FeₑNi_{f} where a, b, c, d, e and f are comprised between 1 and 55 at. %.
the high-entropy alloy may satisfy the following formula: Cr_{18.2}Fe_{18.2}CO_{18.2}Ni_{18.2}Cu_{18.2}Al_{9.0}.

Advantageously, the high-entropy alloy may contain one or more interstitial elements from among the following: C, N, B. These interstitial elements further increase the mechanical strength of the alloy.

Advantageously, the high-entropy alloy may contain one or more structural hardening elements from among the following: Ti, Al, Be, Nb, preferably in a mass concentration comprised between 0.1 and 3%.

According to different embodiments, the timepiece component may be one of the following: a spring, a mainspring, a jumper spring, an impulse pin, a roller, pallets, a staff, a pallet lever, a pallet fork, a wheel, an escape wheel, an arbor, a pinion, an oscillating weight, a winding stem, a crown, a watch case, a bracelet link, a watch bezel, a bracelet clasp.

A second aspect of the invention also concerns the use of a high-entropy alloy for fabricating a timepiece component, the high-entropy alloy containing between 4 and 13 main alloying elements forming a single solid solution, the alloy having a concentration of each main alloying element comprised between 1 and 55 at. %.

### BRIEF DESCRIPTION OF THE DRAWINGS

Other features and advantages of the present invention will appear more clearly in the following detailed description of preferred embodiments, given by way of non-liming examples with reference to the appended Figures, in which:

1 schematically represents a mainspring according to one embodiment of the invention;

FIG. 2 schematically represents the steps of a method for fabricating a mainspring according to one embodiment of the invention.

### DETAILED DESCRIPTION

FIG. 1 schematically represents a mainspring 1 according to one embodiment of the invention. This mainspring 1 is made of a high-entropy alloy.

In such a high-entropy alloy, the entropy of mixing is high and makes the single phase more thermodynamically stable than the mixing of several phases.

The mainspring is preferably made from the high-entropy alloy described in the publication ‘Metastable high-entropy dual-phase alloys overcome the strength-ductility trade-off’, Zhiming Li et al, Nature 534, 227-230 (9 Jun. 2016). This high-entropy alloy has the following formula: Fe₈₀₋ₓMnₓCo₁₀Cr₁₀. x is preferably comprised between 25 and 79 at. %.

More precisely, according to a first embodiment, the mainspring may be made from a Fe₃₅Mn₄₅Co₁₀Cr₁₀ alloy. The mainspring produced in this manner has the advantage of combining high tensile strength and high ductility.

According to a second embodiment, the mainspring may be made from a Fe₄₀Mn₄₀Co₁₀Cr₁₀.alloy. The spring produced in this manner has the advantage of high tensile strength and high ductility. It also operates according to a TWIP (twinning induced plasticity) mechanism.

According to a third embodiment, the mainspring may be made from a Fe₄₈Mn₃₅Co₁₀Cr₁₀.alloy. The mainspring produced in this manner has the advantage of having even higher tensile strength and higher ductility. It also operates according to a TRIP (transformation induced plasticity) mechanism.

According to a fourth embodiment, the mainspring can be made from a Fe₅₀Mn₃₀Co₁₀Cr₁₀ alloy. The mainspring produced in this manner has the advantage of having even higher tensile strength and higher ductility. It operates according to a TRIP mechanism with the appearance of two phases, FCC and HCP, by a twinning mechanism.

The invention is not limited to fabrication of a mainspring. Indeed, other timepiece components could be fabricated from the high-entropy Fe₈₀₋ₓMnₓCo₁₀Cr₁₀ alloy, such as a spring, a staff, an impulse pin, a balance, an arbor, a roller, pallets, a pallet lever, a pallet fork, an escape wheel, a shaft, a pinion, a an oscillating weight, a winding stem, a crown, a jumper spring, a watch case, a bracelet link, a watch bezel, a bracelet clasp . . .

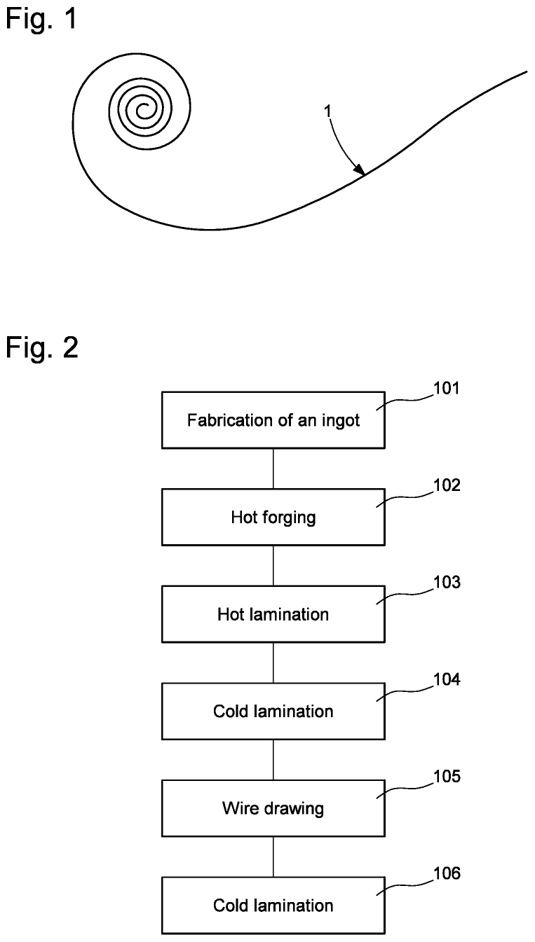

FIG. 2 schematically represents the steps of a method for fabricating the mainspring of FIG. 1.

This method includes a first step 101 of fabricating a high-entropy alloy ingot. To do so, the elements are mixed in pure or pre-alloy form, they are then melted, and the mixture is cast to form an ingot.

The method then includes a step 102 of hot forging the ingot.

The method then includes a hot lamination step 103.

The method then includes a cold lamination step 104.

The method then includes a wire drawing step 105.

The method then includes a cold lamination step 106.

Naturally, the invention is not limited to the embodiments described with reference to the Figures and variants could be envisaged without departing from the scope of the invention.

Thus, in the preceding examples, the Fe₈₀₋ₓMnₓCo₁₀Cr₁₀ alloy was used. However, other high-entropy alloys could be used, such as, for example:
Fe₂₀Mn₂₀Ni₂₀Co₂₀Cr₂₀,
Fe₄₀Mn₂₇Ni₂₆Co₅Cr₂,
Ta₂₀Nb₂₀Hf₂₀Zr₂₀Ti₂₀,
Al₂₀Li₂₀Mg₁₀Sc₂₀Ti₃₀,
Cr_{18.2}Fe_{18.2}Co_{18.2}Ni_{18.2}Cu_{18.2}Al_{9.0}.

1: A timepiece component, comprising:
a high-entropy alloy,
wherein the high-entropy alloy is formed of multiple metallic elements forming a single-phase structure, and
the high-entropy alloy satisfies formula FeₐMn_{b}Co_{c}Cr_{d}, or formula Fe₈₀₋ₓMnₓCo₁₀Cr₁₀, or formula FeₐMn_{b}NiₑCo_{c}Cr_{d}, or formula AlₐLi_{b}Mg_{c}Sc_{d}Tiₑ, where a, b, c, d, and e, when present, are each a value independently ranging from 1 to 55 at. %, and where x, when present, is a value ranging from 25 to 79 at. %.

2: The timepiece component according to claim 1, wherein the high-entropy alloy satisfies formula:
FeₐMn_{b}Co_{c}Cr_{d},
wherein a, b, c and d are from 1 to 55 at. %.

3: The timepiece component according to claim 1, wherein the high-entropy alloy satisfies formula:
Fe₈₀₋ₓMnₓCo₁₀Cr₁₀,
wherein x is from 25 to 79 at. %.

4: The timepiece component according to claim 1, wherein the high-entropy alloy satisfies formula:
FeₐMn_{b}NiₑCo_{c}Cr_{d},
wherein a, b, c, d and e are from 1 to 55 at. %.

5: The timepiece component according to claim 1, wherein the high-entropy alloy satisfies formula:
AlₐLi_{b}Mg_{c}Sc_{d}Tiₑ,
wherein a, b, c, d and e are from 1 to 55 at. %.

6: The timepiece component according to claim 1, wherein the high-entropy alloy comprises one or more interstitial elements selected from the group consisting of C, N, and B.

7: The timepiece component according to claim 1, wherein the high-entropy alloy comprises one or more structural hardening elements selected from the group consisting of Ti, Al, Be, and Nb.
